(19) United States
(12) Patent Application Publication
(10) Pub. No.: US 2018/0014102 A1
(43) Pub. Date: Jan. 11, 2018

(54) Variable Positioning of Distributed Body Sensors with Single or Dual Wireless Earpiece System and Method

(71) Applicant: BRAGI GmbH, München (DE)

(72) Inventors: Eric Christian Hirsch, München (DE); Peter Vincent Boesen, München (DE)

(73) Assignee: BRAGI GmbH, München (DE)

(21) Appl. No.: 15/642,582

(22) Filed: Jul. 6, 2017

Related U.S. Application Data
(60) Provisional application No. 62/358,743, filed on Jul. 6, 2016.

(51) Int. Cl. H04R 1/10; H04M 1/60; H04R 5/033; H04R 25/00

(52) U.S. Cl. CPC H04R 1/1016; H04R 25/55; H04M 1/6066; H04R 5/033; H04R 2420/07

(57) ABSTRACT

A method of location determination using a first wireless earpiece includes receiving a first set of global navigation satellite system (GNSS) satellite signals at a first GNSS antenna of the first wireless earpiece, determining a GNSS position of a user of the first wireless earpiece from the first set of GNSS satellite signals, and augmenting the GNSS position of the user of the first wireless earpiece using position information from a second wearable device of the user to provide a location determination more accurate than the GNSS position of the user determined using the GNSS satellite signals at the first GNSS antenna of the first wireless earpiece.

### PRIORITY STATEMENT

This application claims priority to U.S. Provisional Patent Application 62/358,743, filed on Jul. 6, 2016, and entitled Variable Positioning of Distributed Body Sensors with Single or Dual Earpiece GNSS Localization System and Method, hereby incorporated by reference in its entirety.

### FIELD OF THE INVENTION

The present invention relates to wearable devices. More particularly, but not exclusively, the illustrative embodiments relates to wireless earpieces and location determination.

### BACKGROUND

Location technology for determining the position of users and devices has improved exponentially in recent years. However, there continue to be issues with locating position information based on line of sight problems. Furthermore, the level of detail and associated information provided may be limited. What is needed are new and improved methods of location determination.

### SUMMARY

Therefore, it is a primary object, feature, or advantage to improve over the state of the art.

It is a further object, feature, or advantage to provide an ability to calculate a user location from global navigation satellite system (GNSS) data in line of sight with one or more sensors in a wireless earpiece.

It is a still further object, feature, or advantage to incorporate data provided from additional devices to assist in locating the user.

Yet another object, feature, or advantage is to provide for image, audio, and sensor analysis to assist in locating the user.

Yet another object, feature, or advantage is to protect the user if the user encounters hazardous conditions.

One embodiment provides a system, method, and wireless earpieces for communication. The wireless earpieces are initialized for communications. Satellite data is received through the wireless earpieces. A location of the user is determined utilizing at least the satellite data. The location of the user is communicated. Another embodiment provides a processor for executing a set of instructions and a memory for storing the set of instructions. The set of instructions are executed to perform the methods herein described.

In one implementation, a system includes an earpiece having a housing with an external surface, at least one sensor mounted onto the external surface of the housing wherein each sensor is in line of sight with at least one GNSS satellite array and configured to detect and receive satellite signals from each GNSS satellite array, at least one processor disposed within the earpiece and operatively connected with the sensors, wherein the at least one processor is configured to calculate a user location from the satellite signals received from each sensor, and an output device mounted onto the external housing and operatively connected to the at least one processor, wherein the output device is configured to provide the user location.

One or more of the following features may be included. The output device may be a LED display. The output device may also be a speaker. One or more processors may transmit audio warnings to the speakers if a hazardous condition is encountered which is subsequently retransmitted by the speakers to a user's eardrums. A transceiver may be disposed within the earpiece and operatively connected to one or more processors. A data storage device may be operatively connected to one or more processors. A microphone may be mounted onto the external surface of the housing, operatively connected to one or more processors, and configured to receive audio signals. One or more processors may be further configured to calculate a user's location based upon audio signals received from one or more microphones. A camera may be mounted onto an external surface of the housing, operatively connected to one or more processors, and configured to take location photos. A power source may be operatively connected to each processor, each sensor, the transceiver, each microphone, the camera, the output device, and the data storage device. The earpiece may comprise a set of wireless earpieces, which may be configured to provide audio signals to the user's eardrums. One or more external electronic devices in line of sight with one or more GNSS satellite arrays may be configured to capture external data regarding the user's location. The external electronic device may be a wireless consumer device, which may be carried around by the user. One or more processors may be further configured to compare the location photos to images in a database, which may be programmed within the data storage device or the external electronic device.

In another implementation, a method of locating the user includes receiving, via at least one sensor in line of sight with at least one GNSS satellite array, satellite data from one or more GNSS satellite arrays, calculating a user location from the satellite data using one or more processors, and providing the user location to the user using one or more output devices.

One or more of the following features may be included. The output device may be a speaker. The speaker may provide date and time information. The output device may also be a LED display. The speaker may provide a warning to the user if a hazardous condition is encountered. External satellite data from an external device may be received by one or more sensors. One or more processors may further calculate a user's location using the external satellite data. A microphone may receive audio signals, which may then be used by one or more processors to help calculate a user's location. Location images from a camera may be received by one or more processors, which may then compare the location images to data stored in a database, which may me located with a data storage device within an earpiece, an external device, or a combination of both storage devices.

According to another aspect, a method of location determination using a first wireless earpiece is provided. The method includes receiving a first set of global navigation satellite system (GNSS) satellite signals at a first GNSS antenna of the first wireless earpiece, determining a GNSS position of a user of the first wireless earpiece from the first set of GNSS satellite signals. The method further includes augmenting the GNSS position of the user of the first wireless earpiece using position information from a second wearable device of the user to provide a location determination more accurate than the GNSS position of the user determined using the GNSS satellite signals at the first GNSS antenna of the first wireless earpiece. The second wearable device may include a second GNSS antenna for receiving a second set of GNSS satellite signals, wherein the first set of GNSS satellite signals is from a set of satellites different from the second set of GNSS satellite signals.

One or more of these and/or other objects, features, or advantages of the illustrative embodiments will become apparent from the specification and claims that follow. No single embodiment need provide each and every object, feature, or advantage. Different embodiments may have different objects, features, or advantages. Therefore, the illustrative embodiments are not to be limited to or by an object, feature, or advantage stated herein.

### BRIEF DESCRIPTION OF THE DRAWINGS

Illustrated embodiments are described in detail below with reference to the attached drawing figures, which are incorporated by reference herein, and where:

FIG. 1 is a pictorial representation of a communications environment in accordance with an illustrative embodiment;

FIG. 2 is a pictorial representation of other communications environments in accordance with an illustrative embodiment;

FIG. 3 illustrates a top view of a left wireless earpiece and right wireless earpiece in accordance with an illustrative embodiment;

FIG. 4 illustrates a side view of a right wireless earpiece and its relationship with a user's ear in accordance with an illustrative embodiment;

FIG. 5 further illustrates a block diagram of wireless earpieces in accordance with an illustrative embodiment;

FIG. 6 illustrates a flowchart of a process for performing satellite communications in accordance with an illustrative embodiment;

FIG. 7 includes a flowchart of one implementation of the method of locating a user.

FIG. 8 includes a flowchart of another implementation of the method of locating a user.

### DETAILED DESCRIPTION

The illustrative embodiments provide a system, method, and wireless earpieces for performing location based tracking utilizing wireless earpieces. It is to be understood that although various embodiments are shown and described, features of one embodiment may be included in other embodiments and thus the various embodiments are not to be considered exclusive of one another. The wireless earpieces are worn in the ear of the user. The wireless earpieces may track one or more users to facilitate any number of business, entertainment, or personal processes. In one embodiment, any number of global navigation satellite systems (GNSS), cellular, data, or wireless networks, or other networks may be utilized. The wireless earpieces may function together to better provide location data relating to the wearer(s) of the wireless earpieces. The wireless earpieces may determine the location of the location and orientation of the user. The wireless earpieces may also communicate with any number of other wireless communications, entertainment, wearable, personal, industrial, or other electronic devices.

For example, the wireless earpieces may work in combination with one or more wireless devices to store applicable data and information, such as location, orientation, link/connection information, identifiers, descriptions, and so forth. For example, global positioning information, wireless triangulation data, or other location information may be associated with each of the wireless earpieces whether worn by a single user or multiple users to facilitate locating the position, movement, and orientation of the user. In addition, an owner, contact information, device type, identifier, or other information may be associated with the wireless earpieces. Authorization to track the wireless earpieces may be based on one or more passwords, secure identifiers, biometrics, or so forth that may be stored or accessed by the wireless earpieces.

In one embodiment, the wireless earpieces may work in combination with a dynamic or static wireless device, such as a cell phone, smart card, smart wearable (e.g., watch, ring, etc.), radio frequency identification tag, or so forth. The biometric readings of the user may be determined from a pair of wireless earpieces or a single wireless earpiece worn by the user. The description included herein may refer to the wireless earpieces individual or collectively.

The wireless earpieces represent a smart wearable device that may be worn within the ears of the user. As with all personal devices, the wireless earpieces may store valuable personal information including name, address, age, sex, user preferences, user biometrics, user financial information for implementing transactions (e.g., debit/credit card numbers, account numbers, user names, passwords, pins, etc.), location information, and other sensitive personal information. The wireless earpieces include a number of sensors that may be configured to read biometric and environmental information associated with the user. The wireless earpieces may also receive user input from the user including gestures, voice commands, motions, taps, swipes, or other forms of feedback. The biometric information may include heart rate or pattern, fingerprints, mapping of the user's ear/head, voice analysis, skin conductivity, height determinations, and so forth. The biometric readings or information may also be stored for any number of purposes including health monitoring, identification, tracking, and so forth.

The movements of the tag and/or wireless earpieces and an associated wireless device may be recorded and accessed for finding or determining the location, position, and activity of the user utilizing the wireless earpieces or vice versa. Any number of wireless communications standards, protocols, networks, or signals may be utilized for communication with or tracking the wireless earpieces. For example, Wi-Fi, Bluetooth, cellular, satellite/GNSS, near-field magnetic induction (NFMI) communication, or any number of other standards may be utilized. The wireless earpieces may utilize global positioning information, systems, and data as well as other location techniques (e.g., signal strength, wireless triangulation, transponder detection, etc.) to track the wireless earpieces and any associated devices.

The wireless earpieces may also provide additional information determined, such as length of time in the current location, movement characteristics (e.g., heading, speed, path, etc.), most recent time of movement, motion relative to other devices, user provided description of the location, and other relevant information. The illustrative embodiments provide additional security because the use of a screen or display is not required. For example, the information may be communicated directly from the wireless earpieces to other devices or to the user audibly providing enhanced privacy. The user may specify that only authorized or otherwise specified users are allowed to track the wireless earpieces. For example, identifying biometric information and/or user input may be required to identify and authenticate the user. The wireless earpieces may also send and receive communications directly or indirectly (e.g., networks, connection through a wireless device, etc.) from the wireless earpieces.

The illustrative embodiments may allow a user to loan the wireless earpieces to another user without concern for breaching or contamination of their own unique personal biometric data. In one embodiment, the primary or administrative user may establish profiles for any number of users that may utilize a single set of wireless earpieces. For example, the primary user may control the user profiles of the secondary users that allows or prevents location services and processes being performed when worn by the secondary users. As a result, any number of users may be able to control and manage access to different data, functions, and so forth available through the wireless earpieces.

The wireless earpieces are configured to fit at least partially into an external auditory canal of the user. The ear canal is a rich space for obtaining biometric measurements about the user as well as stabilizing the wireless earpieces as they are worn. The wireless earpieces may be utilized during a number of rigorous physical activities that require stability. The shape and configuration of the wireless earpieces allow the wireless earpieces to be worn for long periods of time while gathering valuable information utilizing the sensors of the wireless earpieces. The wireless earpieces may include sensors for measuring pule rate, blood oxygenation, microphone, position/orientation, location, temperature, altitude, cadence, calorie expenditure, and so forth. The sensors may include electrical contacts that interact with the ear/body of the user. In one embodiment, the sensors may be utilized to use the user's body to enhance reception of signals. For example, the body of the user may be utilized as an antenna to enhance reception of various signals or communications.

The wireless earpieces may include any number of sensor arrays configured to capture information about the user. The large amount of data may be utilized to authenticate the user for any number of requests, such as sending location and orientation information. The wireless earpieces may configure themselves to perform various functions as well as sending commands to any number of proximate devices to implement actions, commands, or requests, or transactions. The wireless earpieces may learn over time in response to selections made utilizing the wireless earpieces or interconnected devices, such as a cell phone. The sensors may sense dynamic manifestations including movement patterns, fluidity, hesitations, volume of the voice, amplitude and frequency modulations (e.g., jitter, shimmer rates, etc.) temperature fluctuations, increases or decreases in heart rate, and level of sweat production for comparison utilizing logic of the wireless earpieces to generate one or more actions. Alerts may be played to the user indicating the status of a location request (e.g., initiated, in process, awaiting user verification, approved, rejected, etc.).

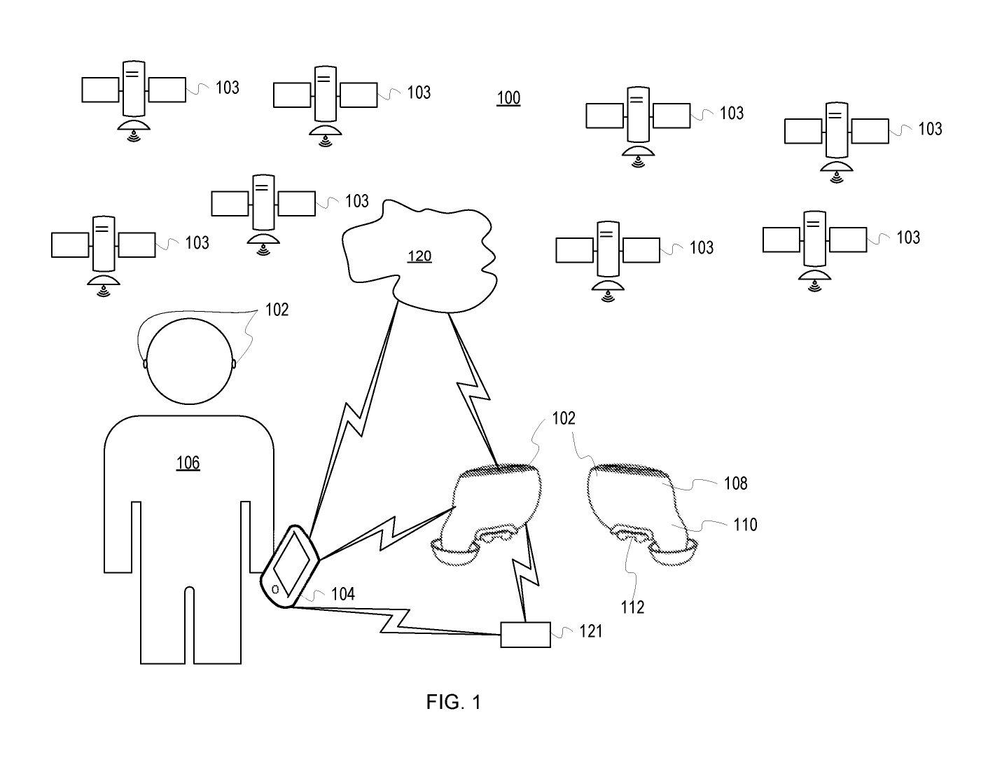

FIG. 1 is a pictorial representation of a communication environment 100 in accordance with an illustrative embodiment. The wireless earpieces 102 may be configured to communicate with each other and with one or more wireless devices, such as satellites 103 and wireless device 104. The wireless earpieces 102 may be worn by a user 106 and are shown both as worn and separately from their positioning within the ears of the user 106 for purposes of visualization.

In one embodiment, the wireless earpieces 102 include a frame 108 shaped to fit substantially within the ears of the user 106. The user 106 may also represent one or more third parties that may receive location, orientation, biometric, and other information associated with the wireless earpieces 102. The frame 108 is a support structure that at least partially encloses and houses the electronic components of the wireless earpieces 102. The frame 108 may be composed of a single structure or multiple structures that are interconnected. The frame 108 defines an extension 110 configured to fit substantially within the ear of the user 106. The extension 110 may house one or more speakers, ear-bone microphones, or vibration components for interacting with the user. The extension 110 may be removable covered by one or more sleeves. The sleeves may be changed to fit the size and shape of the user's ears. The sleeves may come in various sizes and have extremely tight tolerances to fit the user 106 and one or more other users that may utilize the wireless earpieces 102 during their expected lifecycle. In another embodiment, the sleeves may be custom built to support the interference fit utilized by the wireless earpieces 102 while also being comfortable while worn. In one embodiment, all or portions of the frame 108, extension 110, and sleeves may be custom shaped to best fit the user. For example, custom rubber or polymer molding may be utilized to ensure at tight fit and seal when worn by the user 106.

In one embodiment, the frame 108 or the extension 110 (or other portions of the wireless earpieces 102) may include sensors 112 for sensing pulse, blood oxygenation, temperature, voice characteristics, skin conduction, glucose levels, impacts, activity level, position, location, orientation, as well as any number of internal or external user biometrics. A first set of the sensors 112 may represent external sensors that may sense user gestures, contact, motions, fingerprints, and external conditions (e.g., temperature, humidity, pressure, etc.). A number of the sensors 112 may also be internally positioned within the wireless earpieces 102. For example, the sensors 112 may represent metallic contacts, optical interfaces, electrical contacts, thermometers, or micro-delivery systems for receiving and delivering information. Small electrical charges may be sensed within the ear of the user 106 as well as passed through the sensors 112 to analyze the biometrics of the user 106 including pulse, skin conductivity, temperature, blood analysis, sweat levels, and so forth. Sensors 112 may also be utilized to provide a small electrical current which may be useful for alerting the user, stimulating blood flow, alleviating nausea, or so forth.

In some applications, temporary adhesives or securing mechanisms (e.g., clamps, straps, lanyards, extenders, chargers, portable battery packs, etc.) may be utilized to ensure that the wireless earpieces 102 remain in the ears of the user 106 even during the most rigorous and physical activities. For example, the wireless earpieces 102 may be utilized during marathons, swimming, team sports, biking, hiking, parachuting, or so forth. The wireless earpieces 102 may be configured to play music or audio, receive and make phone calls or other communications, determine ambient environmental conditions (e.g., temperature, altitude, location, speed, heading, etc.), read user biometrics (e.g., heart rate, motion, temperature, sleep, blood oxygenation, voice output, calories burned, forces experienced, etc.), and receive user input, feedback, or instructions. The wireless device 104 or the wireless earpieces 102 may communicate directly or indirectly with one or more wired or wireless networks, such as a network 120. The wireless earpieces 102 may include logic for dynamically configuring components of the wireless earpieces 102, such as speakers and microphones, to the conditions of the communication environment 100. As a result, application implementation, music playback, and real-time communications may be adapted as needed.

The wireless earpieces 102 may be shaped and configured as wireless earbuds, wireless headphones, or other headpieces, personal speaker/communications devices, or earpieces any of which may be referred to generally as the wireless earpieces 102. In one example, the headphones (not shown) may include sensors that are not within the ear canal. For example, the headphones may include sensors that are integrated with an over-head support, ear pads/cups, a frame, or so forth. The biometrics may be measured from the user's head (e.g., ears, neck, ears, scalp, skin, etc.) or body. The information may also be associated with the environment, user activity/actions, ambient, or so forth. Electrical components, such as antennas or transceivers may be positioned at the top of the head to enhance communication with devices, such as the satellite 103.

The wireless earpieces 102 may determine their position with respect to each other as well as devices, systems, equipment, or components, such as the satellites 103 and the wireless device 104. For example, position information for the wireless earpieces 102, the satellite 103, and the wireless device 104 may determine proximity of the devices in the communication environment 100. The satellites 103 may represent any number of satellites, satellite arrays, satellite systems, such as a GNSS system (e.g., GPS, GLONASS, Galileo, Beidou, regional systems, etc.) that may include numerous satellites, GNSS broadcast signals, GNSS control channels, data uploading stations, master control stations, base stations, and additional users (e.g., utilizing wireless earpieces, portable wireless devices, wired devices, etc.). The signals transmitted by a GNSS satellite array may be radio waves or any other type of signal that is electromagnetic in nature. The satellites 103 may also represent any number of other satellite, aerial (e.g., blimp, UAV, balloon, etc.), or other communications. For example, the satellites 103 may also represent a global positioning system utilized by the wireless earpieces 102.

It is to be understood that different earpieces may have line of sight with different sets of satellites. Thus, for example, a left earpiece may have a first set of satellites in view and thus receive signals from the first set of satellites while a right earpiece may receive signals from the second set of satellites. Thus, where a first antenna is on the left ear piece and a second antenna is on the right ear piece, different sets of satellites may be used for location determination of each of the earpieces. One set of the satellites may result in a more accurate location determination than reliance on the other set of the satellites. For example, if more satellites are in line of sight for the left earpiece than the right earpiece, a more accurate determination may be made using the satellite signals of the left earpiece. Similarly, instead of a left ear piece and a right earpiece, antennas and/or GNSS receivers may be associated with other wearable devices to allow for different sets of satellites to be in view at different times. In some embodiments, only the appropriate antennas need be present in the wearable devices and the GNSS receivers may be located elsewhere on the body. A single GNSS receiver may be used along with an appropriate RF switch or other circuitry to allow the single GNSS receiver to resolve location from different GNSS antennas.

In addition, to the components described, the wireless earpieces 102 may further include a beacon, tracker, smart sticker, radio frequency identification (RFID) device, and any number of currently available or developing devices. All or portions of the components of the wireless earpieces 102 may be actively or passively powered utilizing batteries, fuel cells, induction circuits, solar cells, piezo electric generators, chemical generators, miniature wind turbines, or so forth. For example, global positioning information, wireless triangulation, or signal strength/activity may be utilized to determine proximity and distance of the devices to each other in the communication environment 100 as well as individual location and orientation information. The initial location/orientation, last known location/orientation, or inferred location/orientation may be stored with memories of the wireless earpieces 102, the wireless device 104, or other electronics of the communications environment 100.

In one embodiment, the location, position, and orientation information may be utilized to provide the user 106 or a third-party directions or instructions. In one embodiment, the directions may be provided audibly to the user (e.g., go straight 200 feet and then left 100 feet, go northeast 30 meters, look behind you 10 feet, etc.). The directions may also be provided through the wireless device 104 utilizing an application specific interface. Directions may also be provided tactilely (e.g., one vibration—straight, two vibrations—right, three vibrations—left, four vibrations—backwards, etc.). In one embodiment, the distance information may be utilized to determine whether the wireless earpieces 102 are both being worn (e.g., should be experiencing similar environmental conditions, noise, etc.), worn by different users, or whether a single wireless earpiece 102 is being worn. In another embodiment, a secondary user may receive information regarding the location, position, and orientation of the user for tracking, commercial processes, recreation, or safety purposes.

In one embodiment, the wireless earpieces 102 and the corresponding sensors 112 (whether internal or external) may be configured to take a number of measurements or log information during normal usage. The sensor measurements may be utilized to extrapolate other measurements, factors, or conditions applicable to the user 106. For example, the sensors 112 may monitor the user's heartbeat or EKG to determine the user's unique pattern or characteristics. The user 106 or another party may configure the wireless earpieces 102 directly or through a connected device and application (e.g., mobile app with a graphical user interface) to store or share location or identification information, audio, images, and other data. In addition to communicating with the satellite 103, the wireless earpieces 102 may also communicate with the network 120 which may represent any number of cellular, Wi-Fi, or other wireless networks. The wireless earpieces 102 may be configured to communicate with any number of preset devices or users.

Some examples of standard usage of the wireless earpieces 102 may include detecting and recording a heartbeat, setting a biometric information for identification of a user and locating the tag 121, setting noise thresholds and the associated speaker volume level or microphone sensitivity, setting a user specified gesture/input for performing an action (e.g., playing music, opening an application, providing an audio indication of biometric feedback, etc.), active participation in a conversation, listening to music, or so forth. As a result, the wireless earpieces 102 may be customized to detect and locate the user 106 including location, position, orientation, activity and so forth. The applicable information may be logged, queued, or otherwise stored for subsequent reference by the logic of the wireless earpieces 102 as well as available devices, such as the wireless device 104. A combination, sequence, or concurrent receipt of biometrics and user input may be associated with each or both of the wireless earpieces to ensure secure access. Thus, access to various tags as well as the associated features, functions, and data may be secured and protected utilizing unique identifiers. Distinct user profiles and preferences may be utilized to ensure that multiple users may utilize the wireless earpieces 102 with data, functionality, and access for each user being completely secured.

In one embodiment, each of the sensors 112 of the wireless earpieces 102 may perform baseline readings to determine which user is utilizing the wireless earpieces 102 and to adapt to communications environments 100 that may be quiet, slightly noise, loud, or anything in between. For example, the wireless earpieces 102 may determine which of a number of users (or guests) is associated with the wireless earpieces 102. The wireless earpieces 102 may also determine the applicable communications environment 100 (e.g., the user's home, train station, work out areas, office environment, mechanical shop, sports venue, etc.). In one embodiment, the wireless earpieces 102 may determine associated electronic devices, data, functions, and features that may be accessed based on the user, the user's authorization level, location, activity, and so forth. The components of the wireless earpieces 102, such as the speakers and microphones may then be self-adjusted based on the identified user and information associated with the communications environment 100. For example, the location may be determined differently and communications may be performed distinctly indoors (e.g., wireless triangulation, signal strength measurements, etc.) as compared to outdoors (e.g., global positioning information, proximity data, mesh networks, etc.).

The wireless earpieces 102 may include any number of sensors 112 and logic for measuring and determining user biometrics, such as pulse rate, skin conduction, blood oxygenation, temperature, calories expended, voice and audio output, position, and orientation (e.g., body, head, etc.). The sensors 112 may also determine the user's location, position, velocity, impact levels, and so forth. The sensors 112 may also receive user input and convert the user input into commands or selections made across the personal devices of the personal area network. For example, the user input detected by the wireless earpieces 102 may include voice commands, head motions, finger taps, finger swipes, motions or gestures, or other user inputs sensed by the wireless earpieces 102. The user input may be measured by the wireless earpieces 102 and converted into internal commands (utilized by the wireless earpieces 102 themselves) or external commands that may be sent to one or more external devices, such as the wireless device 104, a tablet computer, or so forth. For example, the user 106 may create a first specific head motion and first voice command that when detected by the wireless earpieces 102 are utilized to automatically record the user's location for communication to a remote device. Any number of user biometrics and user input may be utilized alone, or in combination to unlock partitioned data and functionality to effectively sandbox the wireless earpieces 102.

The wireless earpieces 102 may communicate with any number of other sensory devices in the communication environment 100 to measure information and data about the user 106 and the communication environment 100 itself. In one embodiment, the communication environment 100 may represent all or a portion of a personal area network. The wireless earpieces 102 may be utilized to control, communicate, manage, or interact with a number of other wearable devices or electronics, such as smart glasses, helmets, smart glass, watches or wrist bands, other wireless earpieces, chest straps, implants, displays, clothing, or so forth. A personal area network is a network for data transmissions among devices, such as personal computing, communications, camera, vehicles, entertainment, and medical devices. The personal area network may utilize any number of wired, wireless, or hybrid configurations and may be stationary or dynamic. For example, the personal area network may utilize wireless network protocols or standards, such as INSTEON, IrDA, Wireless USB, Bluetooth, NFMI, Z-Wave, ZigBee, Wi-Fi, ANT+ or other applicable magnetic or radio frequency signals. In one embodiment, the personal area network may move with the user 106.

In other embodiments, the communication environment 100 may include any number of devices, components, or so forth that may communicate with each other directly or indirectly through a wireless (or wired) connection, signal, or link. The communication environment 100 may include one or more networks and network components and devices represented by the network 120, such as routers, servers, signal extenders, intelligent network devices, computing devices, or so forth. In one embodiment, the network 120 of the communication environment 100 represents a personal area network as previously disclosed. The network 120 may also represent a number of different network types and service providers.

Communications within the communication environment 100 may occur through the network 120 or may occur directly between devices, such as the wireless earpieces 102 and the wireless device 104, or indirectly through a network, such as a Wi-Fi network. The network 120 may communicate with or include a wireless network, such as a Wi-Fi, cellular (e.g., 3G, 4G, 5G, PCS, GSM, etc.), Bluetooth, or other short range or long-range radio frequency network. The network 120 may also communicate with a satellite network including the satellite 103. The network 120 may also include or communicate with any number of hard wired networks, such as local area networks, coaxial networks, fiber-optic networks, network adapters, or so forth. Communications within the communication environment 100 may be operated by one or more users, service providers (e.g., secure, public, private, etc.), or network providers.

The wireless earpieces 102 may play, communicate, or utilize any number of alerts or communications to indicate that the status of the access of the searching and location process. For example, one or more alerts may indicate when the wireless earpieces 102 are within direct communication with the satellite 103. The alerts may also indicate whether a remote user or local user is authorized to search for and find the wireless earpieces 102 based on biometric readings, user input, and so forth (e.g., passwords, identifiers, combinations of passwords, sequential verification, etc.). The alert may also indicate directions to get to the wireless earpieces 102 from the current location of an applicable device or user, the battery status of the wireless earpieces 102, and various other available information. The corresponding alerts may also be communicated to the user 106, the wireless device 104, and other specified devices or users.

In other embodiments, the wireless earpieces 102 may also vibrate, flash, play a tone or other sound, or give other indications of the access process status in order to prompt user actions (e.g., giving a sequence of verbal, motion, or audio search instructions, provide additional feedback, etc.) or implement any number of associated steps. The wireless earpieces 102 may also communicate an alert to the wireless device 104 that shows up as a notification, message, or other indicator indicating the necessity for configuration/re-configuration or a changed status of the configuration process, such as an audio alert that “that earpieces have changed locations.”

The wireless earpieces 102, the satellite (and associated system), or the wireless device 104 may include logic for automatically implementing access and authorization in response to wireless earpiece set-up, start-up, condition changes (e.g., location, activities, etc.), event happenings, user requests or various other conditions and factors of the communication environment 100. For example, the wireless device 104 may communicate instructions received from the left wireless earpiece for the user 106 to locate the right wireless earpiece or to unlock the data, functions, and features. The wireless device 104 may include an application that displays instructions and information to a user or device for searching for and locating the wireless earpieces 102.

In addition, to long-range wireless communications through the satellite 103 which may be performed through a satellite connection (e.g., signal, link, path, etc.) The wireless device 104 may utilize short-range or long-range wireless communications to communicate with the wireless earpieces 102 through a wireless signal or devices of the communication environment 100. For example, the wireless device 104 may include a Bluetooth and cellular transceiver within the embedded logical components. For example, the wireless signal may be a Bluetooth, Wi-Fi, Zigbee, Ant+, near-field magnetic induction (NFMI), or other short-range wireless communication.

The wireless device 104 may represent any number of wireless or wired electronic communications or computing devices, such as smart phones, laptops, desktop computers, control systems, tablets, displays, gaming devices, music players, personal digital assistants, vehicle systems, or so forth. The wireless device 104 may communicate utilizing any number of wireless connections, standards, or protocols (e.g., near field communications, NFMI, Bluetooth, Wi-Fi, wireless Ethernet, etc.). For example, the wireless device 104 may be a touch screen cellular phone that communicates with the wireless earpieces 102 utilizing Bluetooth communications. The wireless device 104 may implement and utilize any number of operating systems, kernels, instructions, or applications that may make use of the available sensor data sent from the wireless earpieces 102. For example, the wireless device 104 may represent any number of Android, iOS, Windows, open platforms, or other systems and devices. Similarly, the wireless device 104 or the wireless earpieces 102 may execute any number of applications that utilize the user input, proximity data, biometric data, and other feedback from the wireless earpieces 102 to initiate, authorize, or perform access associated tasks.

As noted, the layout of the internal components of the wireless earpieces 102 and the limited space available for a product of limited size may affect where the sensors 112 and other components may be positioned. The positions of the sensors 112 within each of the wireless earpieces 102 may vary based on the model, version, and iteration of the wireless earpiece design and manufacturing process. The calculation of the user's location by one or more processors or logic components of the wireless earpieces 102 may be performed through the use of a proprietary algorithm stored within the processors/logic. In one example, the data used by one or more processors to calculate the location of the user 106 need not all come from a GNSS signal received at a GNSS antenna of the wireless earpiece 102. The calculation of the user's location may be computed at least in part using a GNSS receiver located within one or more of the earpieces.

In one embodiment, the wireless earpieces 102 may communicate with components or devices worn by the user to enhance communications, reception, or so forth. For example, different portions of the user's body may have better or enhanced line of sight communications with the satellite 103 based on the position and orientation of the body of the user 106 as well as any applicable activity the user 106 is engaged in. For example, if the user 106 is laying on her left side, the left wireless earpiece may not be able to complete the connection 120 to the satellite 103 whereas the right wireless earpiece may have the connection 120 with the satellite 103. In one embodiment, the wireless earpieces 102 may be configured to receive signals received by the body of the user to enhance critical reception.

In one embodiment, the wireless earpieces 102 may include additional sensors 112, such as accelerometers, optical components, beacons, microphones, gyroscopes, and other sensors for determining the location and orientation of the user. For example, determining the location and the position of the user may be particularly important in factory systems to prevent the user 106 from being struck by autonomous vehicles, arms, robotics, drones, fork lifts, transportation devices, other users and so forth. For example, based on the determined position and orientation of the user 106 wearing the wireless earpieces 102 robotic devices may avoid hitting the user. Optical images may be captured, analyzed and utilized to even more exactly determine the location and orientation of the user 106 in the environment. Likewise, audio analysis of sounds, noises, and other audio captured by the cameras of the wireless earpieces 102 may be utilized to determine applicable information, details, and data. As noted, the wireless earpieces 102 may utilize any number of short-range or long-range communications signals, mediums, networks (e.g., satellite, wireless, body area, mesh, etc.), connections or links. For example, the communications infrastructure may be integrated with the communications environment 100 (e.g., factory, business, municipality, school, college, warehouse, sports venue, delivery space, neighborhood, geographic area, home, gym, etc.). The illustrative embodiments provide increasingly accurate position and orientation information as sensed by the wireless earpieces 102 themselves and by external devices. The information may be utilized by the wireless earpieces 102 as well as associated devices that are authorized to receive the applicable information. The illustrative embodiments may be particularly beneficial in dangerous, treacherous, or otherwise busy environments.

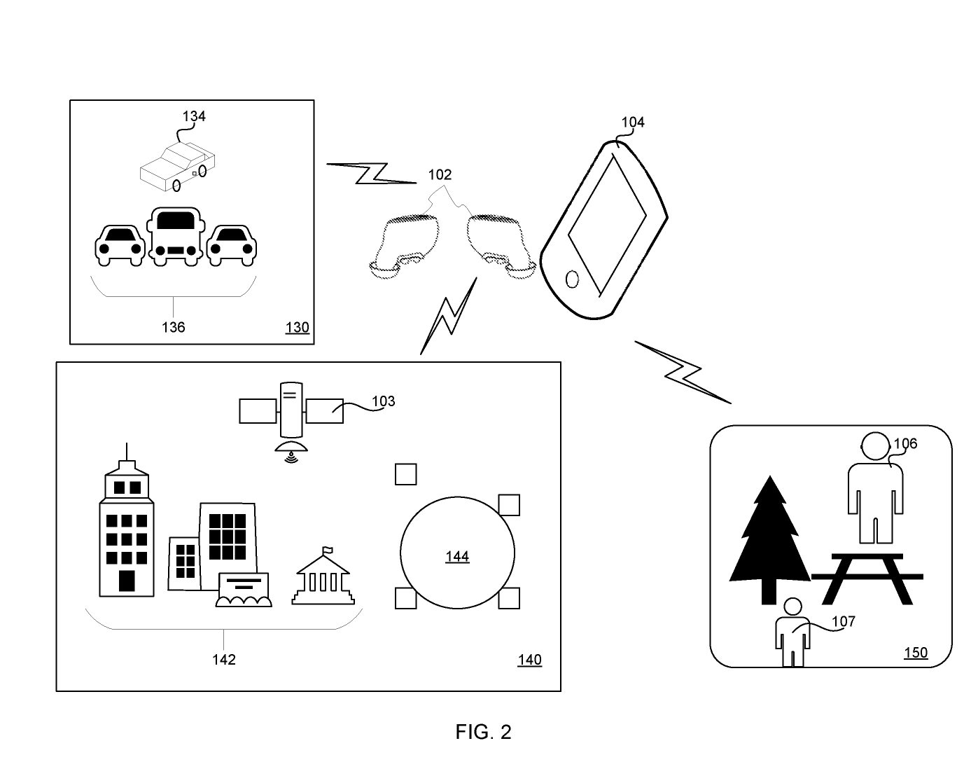

FIG. 2 illustrates a pictorial representation of other communications environments 130, 140, 150 in accordance with illustrative embodiments. The communications environments 130, 140, 150 may represent any number of environments, conditions, locations, structures, or places that a user may visit, travel to, work at, or dwell. In one example, the communications environments 130, 140, 150 may represent different places visited by the user 106 utilizing the wireless earpieces 102.

In one embodiment, the communications environment 130 may represent a parking lot or parking garage where the user 106 may park her car 134. The car 134 may be permanently or temporarily marked with a position (e.g., address, GPS coordinates, etc.) for finding the car 134 in the future and determining the location of the user relative to the car. The communications environment 130 may include a number of cars 136 including the car 134 of the user 106. As a result, it may be difficult to locate the car 134 based on changes in lighting, movement of vehicles, passage of time (e.g., forgetfulness, exhaustion, etc.). Communications with the wireless earpieces 102 and/or wireless device 104 may facilitate the user 106 in finding the car 134. For example, a satellite, cellular, Wi-Fi, or beacon network may be utilized. The wireless earpieces 102 may also store user specified instructions for finding the car 130 in the communications environment 130, such as “remember the North East corner of level 3.” This information may be played back to the user through the wireless earpieces 102 in response to the user nearing or entering the communications environment 130, the user asking about the location of the car 134, or in response to communications signals, links, or pings being established or received by the wireless earpieces 102.

In addition, the wireless earpieces 102 may provide information for other drivers, users, vehicles or devices in the communications environment to help avoid striking the user 106. In addition, the information associated with the user 106 may be utilized to retrieve the user or provide emergency assistance as is needed (e.g., the user 106 is struck by a vehicle, passes out, has a heart attack, etc.).

In one embodiment, the wireless earpieces 102 may store the make, model, VIN number, license plate number, and contact information (e.g. address, phone number, email address, etc.) and other applicable information associated with the user 106 or car 134. The wireless earpieces 102 may also store information applicable to navigating the communications environment 130, receiving assistance, avoiding potential hazards or dangers, and so forth. In the event that the wireless earpieces 102 are stored in the car, the applicable information may also be utilized if the car 134 is stolen, lost, recovered, or in the event of an emergency. In one embodiment, once the car 134 is stopped or parked at the communications environment 130, the wireless earpieces 102 as well as the wireless device 104 may record the time and location of the car 134. The user may also provide user input or feedback that is associated with the vehicle 13, such as parking space number, parking lot number, section, latitude and longitude, or other global positioning information. Any number of Wi-Fi, Bluetooth, cellular, or satellite signals, links, networks, or connections may be utilized in the communications environment 130. In addition, developing communications standards may also be utilized.

In one embodiment, the wireless earpieces 102 may independently guide the user back to the car 134. For example, audio clues, indicators, commands, warnings, alerts, or feedback may be communicated directly to the ears of the user. As a result, privacy is maintained, outside parties are unaware of the direction the user is traveling, and the location of the car 134 is safeguarded. For example, the wireless earpieces 102 may provide verbal commands, such as straight ahead, turn left, turn right, cross the intersection carefully, watch-out for the train tracks, and turnaround to help the user find the car 134 and navigate the communications environment 130 safely. The wireless earpieces 102 may also store a path used when originally leaving the car 134 that may be utilized as a (re-trace route) option available to the user.

The communications environment 140 provides another place that the user 106 may visit. As shown, the communications environment 140 may include any number of buildings 142 as well as a stadium 144 that may be utilized to host sporting events, concerts, meetings, and other activities. As shown, the user 106 may have access to data, information, or details that may be utilized for different situations. The user 106 may navigate any number of buildings for work, entertainment, or regular daily activities while in the communications environment. In one embodiment, the location and orientation of the user 106 may be determined utilizing the satellite 103. In one embodiment, the user 106 may be a manager visiting a factory. The wireless earpieces 102 may include active and passive noise cancellation for touring the facility which may be very loud. Similarly, the wireless earpieces 102 may allow the user to communicate and may provide navigation information, instructions, and safety commands to the user 106. The wireless earpieces 106 may switch between satellite, cellular, Wi-Fi, and beacon communications based on availability and the location of the user 106. As noted, cameras, accelerometers, gyroscopes, microphones, chemical sensors, and other sensors may detect the movement, location, activity (e.g., walking, running, lifting, climbing, etc.) and orientation (e.g., standing, stooped over, prostrate, etc.).

The wireless earpieces 102 may guide the user 106 through one or more open spaces, buildings, or other locations associated with the communications environment 140 with or without communications through the wireless device 104. In one example, tactile commands, such as vibrations or electrical impulses may also be utilized to guide the user. For example, vibrations generated in both ears by the wireless earpieces 102 may indicate to go forward, while vibration pulses in the left wireless earpiece or the right wireless earpiece alone may indicate to go left or right, respectively. Double vibration pulses communicated by the wireless earpieces 102 may indicate for the user to turn around. Pulsing vibrations may indicate there is danger proximate the user 106 and to beware.

The communications environment 150 provides another example of a place that users 106 and 107 may visit. In one embodiment, the user 106 may give one of the wireless earpieces 102 to another user 107 (e.g., friend, guest, child, parent, etc.) to help and track the user. The wireless earpieces 102 may be utilized in conjunction with the wireless device 104 to detect and track the location of the child 154. In one embodiment, the communications environment 150 may represent a park, forest, amusement park, school, or other indoor or outdoor location. The wireless earpieces 102 may further communicate with one or more smart watches, wristbands, anklets, necklaces, labels, clip-ons, or so forth.

The wireless earpieces 102 may provide the user 106 with direct or indirect communications regarding the location of the user 107 as well as other information, such as heading, speed, initial location, last detected location, and activity if known. For example, the user 106 may represent a parent that may get a status update in response to asking a question such as “where is my child?” The wireless earpieces 102 may communicate with each other or the satellite 103 to share applicable information, such as “your child is 30 feet northwest of your location.” The wireless earpieces 102 may also provide feedback to arrive at the position of the user 107 (e.g., child), such as “walk 40 feet forward and 20 feet to the left to find Susie.”

The wireless earpieces 102 may also work with the wireless device 104 to provide feedback to the user 106. The wireless device 104 (or the wireless earpieces 102) may include an internal mapping system, application, database, or so forth that may provide additional details regarding the communications environment 150. For example, an applicable map of the communications environment 150 may indicate obstacles, such as trees, shrubbery, buildings, tables, structures, playground equipment, bathrooms, and so forth. The mapping application may also be utilized to provide audible feedback for the user 106 wearing one or more of the wireless earpieces 102 to find the user 107 wearing one of the wireless earpieces 102. The wireless earpieces 102 may include a database of data for automatically identifying the users 106, 107 from known users utilizing any number of biometrics (e.g., voice analysis, fingerprints, height, skin conductivity, etc.).

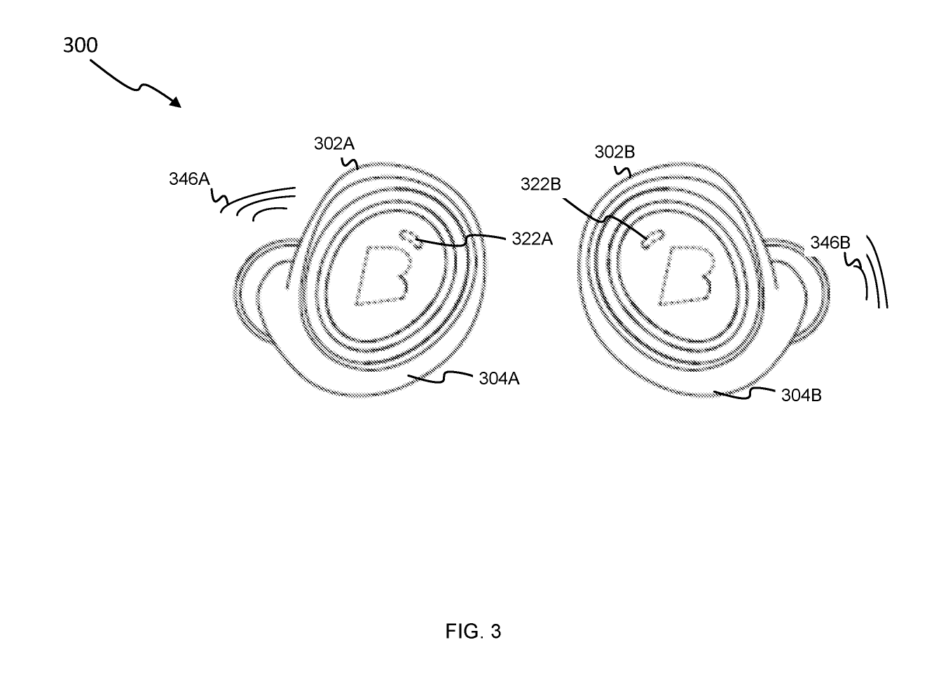

FIG. 3 illustrates a system 300 which includes a left wireless earpiece 302A and a right wireless earpiece 302B. The left wireless earpiece 302A has a left earpiece housing 304A. The right earpiece 302B has a right earpiece housing 304B. The left wireless earpiece 302A and the right earpiece 302B may be configured to either fit around a user's ear canal so as to minimize the amount of external sound capable of reaching the ear canal or configured to fit within the ear canal so as to minimize the distance between the speakers and a user's tympanic membranes.

In one embodiment, the left earpiece housings 304A and 304B may be composed of metallic or plastic materials, and may also be configured as to be waterproof. An external microphone 202A is shown on the left wireless earpiece 302A and an external microphone 322B is shown on the right wireless earpiece 302B. The external microphones 322A and 322B may be located anywhere on the wireless earpieces 302A and 302B respectively. The wireless earpieces 302A and 302B may be configured to transmit audio signals 346A and 346B respectively to provide audio signals to the user.

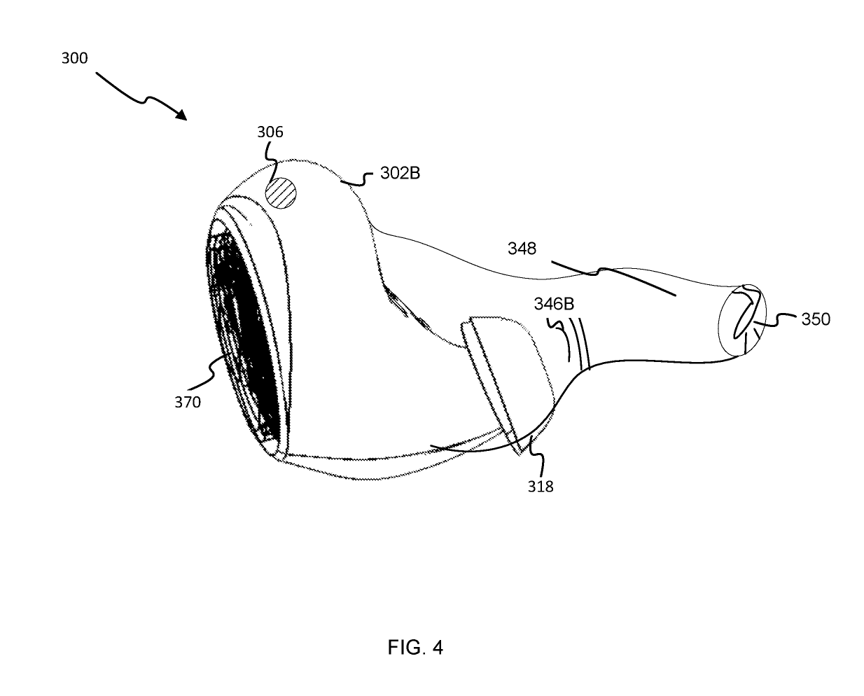

FIG. 4 illustrates a side view of a right wireless earpiece 302B and its relationship with a user's ear. The right wireless earpiece 302B may be configured to fit comfortably within a user's ear canal 348 so as to both minimize the amount of external sound reaching the user's ear canal 348 and to facilitate the transmission of an audio signal 346B from a speaker 318 to a user's eardrum 350.

The right wireless earpiece 302B may be configured to be of any size necessary to fit within the user's ear canal 348 and the distance between the speaker 308 and the user's eardrum 350 may be any distance sufficient to facilitate transmission of the audio signal 346B to the user's eardrum 50. There is a surface 370 shown on the exterior of the right wireless earpiece 346B. In one embodiment, the surface 370 may include one or more infrared, touch, or optical sensors for measuring user input. One or more sensors 306 may be positioned on the surface 370 to be in line of sight of a GNSS satellite array or other wireless communication devices or equipment. For example, the sensor 306 may include a GNSS antenna for communication with one or more GNSS satellite arrays. A GNSS receiver may be disposed within the earpiece. This surface 70 may also provide for gesture control by a user via a gesture control interface such as by tapping, double tapping, or swiping across the surface 370 as well as display information using LED technology to a user or third party via the surface 370.

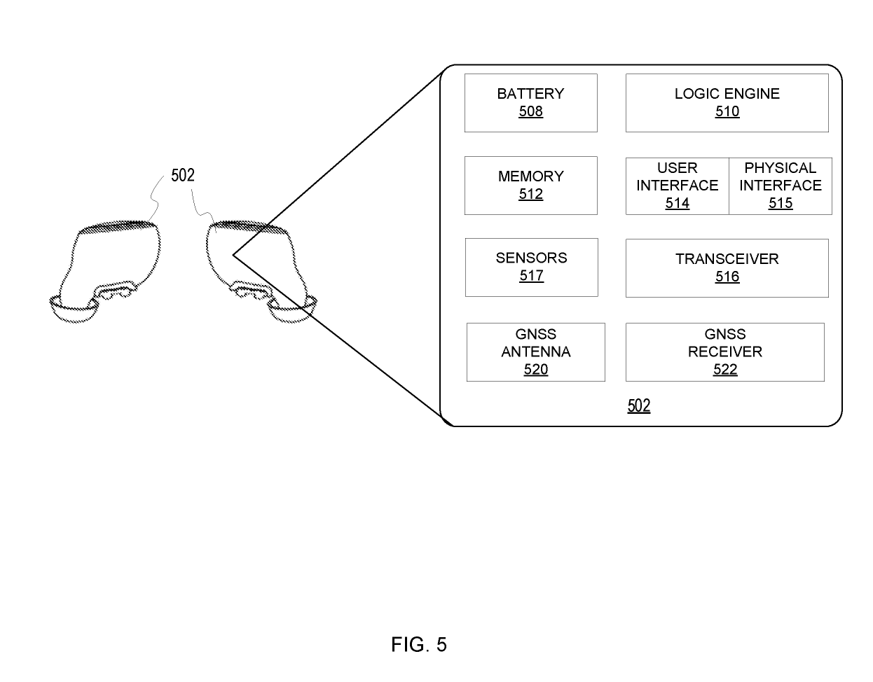

FIG. 5 further illustrates a block diagram of wireless earpieces in accordance with an illustrative embodiment. As noted, the components of the wireless earpieces 502 may be described collectively rather than individually. The wireless earpieces 502 may be wirelessly linked to any number of wireless devices, such as the wireless device 104 of FIG. 1. For example, wireless devices may include wearable devices, communications devices, computers, entertainment devices, vehicle systems, exercise equipment, or so forth. In one embodiment, the wireless earpieces 502 may communicate with the wireless devices to enhance signal reception, communications, biometric readings or so forth. For example, an external antenna/transceiver may augment the capabilities of the wireless earpieces 502 to detect GNSS signals from a satellite system. Sensor measurements, user input, and commands may be received from either the wireless earpieces 502 or the wireless device (not shown) for processing and implementation on any of the devices (or other externally connected devices). Reference to the wireless earpieces 502 may descriptively or functionally refer to either the pair of wireless earpieces (wireless earpieces) together or individual wireless earpieces (left wireless earpiece and right wireless earpiece) without limitation.

In some embodiments, the wireless device may also act as a logging tool for sensor data or measurements made by the wireless earpieces 502. For example, the wireless device may receive and share data captured by the wireless earpieces 502 in real-time including biometric or location information, such as authentication biometrics or input, status of the user (e.g., physical, emotional, etc.), last known location, orientation, and activity of the user, and so forth. As a result, the wireless device may be utilized to store, display, and synchronize sensor data received from the wireless earpieces 502. For example, the wireless device may display user pulse rate, temperature, proximity, location, blood oxygenation, distance, calories burned, and so forth as measured by the wireless earpieces 502. The user or a request may also be authenticated by sending the data to the wireless device that may then authenticate the data and authorize a request, function, feature, or so forth. The wireless device may be configured to receive and display alerts that indicate conditions to initiate, process, and authenticate a search or locate request have been met. For example, if a request is made and the wireless earpieces 502 may automatically display as an alert, message, or in-app communication, such as “please authenticate you have authorized Pete to see your location and activity.” The wireless earpieces 502 and the wireless device may have any number of electrical configurations, shapes, and colors and may include various circuitry, connections, and other components utilized to perform the illustrative embodiments.

In one embodiment, the wireless earpieces 502 may include a battery 508, a logic engine 510, a memory 512, a user interface 514, a physical interface 515, a transceiver 516, and sensors 517. The wireless device may have any number of configurations and include components and features as are known in the art. In addition, the physical positioning of the components may vary based on the types of communications and biometrics being utilized. In one embodiment, the wireless earpieces 502 may also represent wireless headphones (e.g., over-ear, on-ear, in-ear, etc.).

The battery 508 is a power storage device configured to power the wireless earpieces 502. In other embodiments, the battery 508 may represent a fuel cell, thermal electric generator, piezo electric charger, solar charger, ultra-capacitor, or other existing or developing power storage technology. The sensors 517 may also be utilized to measure the temperature of the battery 508 and the conditions and status of internal components of the wireless earpieces. The sensors 517 may also be utilized to determine data about internal and external conditions and factors applicable to the user, the user's environment, a communicating wireless device, or so forth. Other conditions and factors sensed by the sensors 517 (e.g., water/humidity, pressure, blood oxygenation, blood content levels, altitude, position, impact, radiation, etc.) may also be determined with the data being processed by the logic engine 510.

The logic engine 510 is the logic that controls the operation and functionality of the wireless earpieces 502. The logic engine 510 may include circuitry, chips, and other digital logic. The logic engine 510 may also include programs, scripts, and instructions that may be implemented to operate the logic engine 510. The logic engine 510 may represent hardware, software, firmware, or any combination thereof. In one embodiment, the logic engine 510 may include one or more processors. The logic engine 510 may also represent an application specific integrated circuit (ASIC) or field programmable gate array (FPGA). The logic engine 510 may utilize sensor measurements, user input, user preferences and settings, conditions, factors, and environmental conditions to determine the identity of the user, at least in part, from measurements performed by the wireless earpieces 502. This information may also be utilized to authenticate the user. The wireless earpieces 502 may function separately or together to authenticate location, orientation, and activity tracking and communications being performed by an authorized user. For example, processing may be divided between the wireless earpieces 502 to increase the speed of processing and to load balance any processes being performed. For example, a left wireless earpiece may perform imaging of the user's ear to identify the user while the right wireless earpiece may identify voice characteristics of the wireless earpieces. Multiple forms of identifying information may be utilized to better secure requests authenticated through the wireless earpieces.

In one embodiment, the logic engine 510 may perform the authentication determination based on measurements and data from the sensors 517. The logic engine 510 may also perform any number of mathematical functions (e.g. linear extrapolation, polynomial extrapolation, conic extrapolation, French curve extrapolation, polynomial interpretation) to determine or infer the identity of the user from the sensor measurements as well as determine whether a biometric identifier or password is verifiably received. The logic engine 510 may utilize time and other sensor measurements as causal forces to enhance a mathematical function utilized to perform the determinations, processing, and extrapolation performed by the logic engine 510. The logic engine 510 may also perform analysis of signals received from any number of satellite signals to determine the location and orientation of the user. The analysis and applicable determinations may be communicated to other devices as needed through the transceiver 516.

The logic engine 510 may also process user input to determine access commands implemented by the wireless earpieces 502 or sent to the wireless earpieces 502 through the transceiver 516. Specific actions may be allowed based on sensor measurements, extrapolated measurements, environmental conditions, proximity thresholds, and so forth. For example, the logic engine 510 may implement an authentication macro allowing the user to automatically unlock a tracking application utilizing a heartbeat pattern and voice command. In another embodiment, different types of actions may require different levels or combinations of biometric and user information. For example, low value data, such as tag identifier data, may require a single piece of identifying information (e.g., ear mapping) whereas high value data, such as current location of the tag (if known) may require three pieces of identifying information (e.g., skin conductivity, user specified gesture, user sign on to the wireless earpieces 502).

The logic engine 510 is configured to perform all or a substantial portion of the processing needed for the illustrative embodiments. In one embodiment, the logic engine 510 may associate users or devices with the wireless earpieces 502. For example, the logic engine 510 may associate an identifier (e.g., serial number, custom name, etc.) of the wireless earpieces 502 with devices/users by storing the identifier in the memory 512. The logic engine 510 may also track and record the initial or last known location of the wireless earpieces 502. The wireless earpieces 502 may be tracked directly (or indirectly) if within range of the satellites, cellular signals, other users/mesh network nodes, or so forth. The logic engine 510 may also facilitate the user in searching for, locating, and navigating the user or monitoring other wireless earpieces. In one embodiment, the logic engine 510 may execute a mapping application that facilitates the user in driving, walking, writing, or otherwise navigating. For example, the logic engine 510 may provide instructions or commands for the user interface 514 including a speaker, vibrator, or other interface components to navigate. Instructions provided to the user through the speaker of the user interface 514 may be particularly secure because outside parties are not able to easily intercept or listen in to the audio feedback. The logic engine 510 may also manage the location, orientation, and activity information sent to remote parties and devices. In another embodiment, the logic 510 may send a message from the transceiver 516 of one of the wireless earpieces to the other wireless earpiece to play a sound, light up, vibrate, or otherwise communicate with the user of the respective wireless earpiece.

In one embodiment, a processor included in the logic engine 510 is circuitry or logic enabled to control execution of a set of instructions. The processor may be one or more microprocessors, digital signal processors, application-specific integrated circuits (ASIC), central processing units, or other devices suitable for controlling an electronic device including one or more hardware and software elements, executing software, instructions, programs, and applications, converting and processing signals and information, and performing other related tasks.

The memory 512 is a hardware element, device, or recording media configured to store data or instructions for subsequent retrieval or access at a later time. The memory 512 may represent static or dynamic memory. The memory 512 may include a hard disk, random access memory, cache, removable media drive, mass storage, or configuration suitable as storage for data, instructions, and information. In one embodiment, the memory 512 and the logic engine 510 may be integrated. The memory may use any type of volatile or non-volatile storage techniques and mediums. The memory 512 may store information related to the user, wireless earpieces 502, electronic/wireless devices, and other peripherals, such as a wireless device, smart glasses, smart watch, and smart case for the wireless earpieces 502, wearable device, and so forth.

In one embodiment, the memory 512 may store information for locating each of the wireless earpieces 502 (and the associated user). For example, the memory 512 may store a number of images, audio files, videos, beacon information, travel history, signal identifications, or so forth for locating the wireless earpieces. The stored location information may be stored in databases, indices, or other files or memory constructs accessible by the memory 512 for determining the location, activity, status, and other information of the user and wireless earpieces 502.

In one embodiment, the memory 512 may store, display, or communicate instructions, programs, drivers, or an operating system for controlling the user interface 514 including one or more LEDs or other light emitting components, speakers, tactile generators (e.g., vibrator), and so forth. The memory 512 may also store biometric readings, user input required for specified data, functions, or features, authentication settings and preferences, thresholds, conditions, signal or processing activity, historical information, proximity data, and so forth. The memory 512 may also store instructions, applications, or so forth for tracking and locating other wireless earpieces, tags, or devices.

The transceiver 516 is a component comprising both a transmitter and receiver which may be combined and share common circuitry on a single housing. The transceiver 516 may communicate utilizing NFMI, Bluetooth, Wi-Fi, ZigBee, Ant+, near field communications, wireless USB, infrared, mobile body area networks, ultra-wideband communications, cellular (e.g., 3G, 4G, 5G, PCS, GSM, etc.), infrared, or other suitable radio frequency standards, networks, protocols, or communications. For example, the transceiver 516 may coordinate communications and actions between the wireless earpieces 502 utilizing NFMI communications. The transceiver 516 may also be a hybrid transceiver that supports a number of different communications. The transceiver 516 may also detect amplitudes and infer distance between the wireless earpieces 502 and external devices, such as the wireless device, satellites, or a smart case of the wireless earpieces 502. The transceiver 516 may include any number of antennas that may be statically or dynamically activated and utilized to send and receive signals. Different antennas, segments, or configurations may also be utilized based on the needs of the user, location, body orientation, activity, desired communications, and so forth. For example, different antenna segments may be selectively activated for different types of communications (.e.g. Bluetooth, NFMI, etc.) and activities (e.g., walking, biking, swimming, expeditions, emergency conditions, avalanches, caving, etc.).

A GNSS receiver 522 is also shown which may be operatively connected to a GNSS antenna 520. The GNSS receiver 522 may be used to receive GNSS signals from a plurality of

GNSS satellites used to determine position by the GNSS receiver. In one embodiment, the logic engine 510 may be configured to determine a location of the wireless earpieces 502 utilizing satellite or wireless signals, signal strength, wireless triangulation, beacons, or directional feedback. For example, using data from one or more antennas that facilitate detecting the amplitude, communicated direction of signals received, and so forth. The wireless earpieces 502 may also utilize the natural signals received by the body to enhance the antenna characteristics and properties of the one or more antennas of the wireless earpieces. In one embodiment, the wireless earpieces 502 may work as separate receivers to determine a distance, orientation, or location of the user. For example, when worn, the wireless earpieces 502 may be separated by a known distance associated with the user's head. The distance between the wireless earpieces 502 as well as the time stamp associated with when a signal was received may be utilized to determine a direction and/or location to the wireless earpieces. Similarly, any number of tables, distances, thresholds, database entries, or historical information may be utilized to determine a location, distance, and direction between the wireless earpieces 502 in a particular environment. The wireless earpieces 502 may also utilize connections with other devices as needed to enhance the capabilities of the transceiver 516. In addition, different offsets may be determined relative to placement of antennas or devices on the body of a user. Thus, for example, not only is the location of a user known, but the location of each body worn device on a user may be determined based on a combination of techniques. Thus, for example, it is known if a watch is on the left wrist or the right wrist of a user, or if a phone is carried on the right side of a user or the left side of the user.

The components of the wireless earpieces 502 may be electrically connected utilizing any number of wires, contact points, leads, busses, wireless interfaces, or so forth. In addition, the wireless earpieces 502 may include any number of computing and communications components, devices or elements which may include busses, motherboards, circuits, chips, sensors, ports, interfaces, cards, converters, adapters, connections, transceivers, displays, antennas, and other similar components. The physical interface 515 is hardware interface of the wireless earpieces 502 for connecting and communicating with wireless devices, tags, or other electrical components, devices, or systems.

The physical interface 515 may include any number of pins, arms, or connectors for electrically interfacing with the contacts or other interface components of external devices or other charging or synchronization devices. For example, the physical interface 515 may be a micro USB port. In one embodiment, the physical interface 515 is a magnetic interface that automatically couples to contacts an interface of a wireless device. In another embodiment, the physical interface 515 may include a wireless inductor for charging the wireless earpieces 502 without a physical connection to a charging device. The physical interface 515 may also include a port or interface for temporarily connecting one or more antennas or external devices.

The user interface 514 is a hardware interface for receiving commands, instructions, or input through the touch (haptics) of the user, voice commands, or predefined motions. For example, the user interface 514 may include a touch screen, one or more cameras or image sensors, microphones, speakers, and so forth. The user interface 514 may be utilized to control the other functions of the wireless earpieces 502. The user interface 514 may include the LED array, one or more touch sensitive buttons or portions, a miniature screen or display, or other input/output components. The user interface 514 may be controlled by the user or based on commands received from the wireless device. For example, the user may turn on, reactivate, implement communications, or provide feedback utilizing the user interface 514.

In one embodiment, the user interface 514 may include a fingerprint scanner that may be utilized to scan a fingerprint (e.g., the index finger) of a user to authenticate a user, request, functionality, or so forth. The user interface 514 of each of the wireless earpieces 502 may store identifying information for one or more fingers. In one embodiment, the fingerprint and other biometric data (e.g., voice data, skin conductivity, height, etc.) of the user may be encrypted and stored within a secure portion of the memory 512 to prevent unwanted access or hacking. The wireless earpieces 502 may also store important biometric data, such as medical information (e.g., medical conditions, allergies, logged biometrics, contacts, etc.) that may be shared in response to an emergency.

In one embodiment, the user may provide user feedback for authenticating a search request by tapping the user interface 514 once, twice, three times, or any number of times (e.g., sequentially or in a timed pattern). Similarly, a swiping motion may be utilized across or in front of the user interface 514 (e.g., the exterior surface of the wireless earpieces 502) to implement a predefined action. Swiping motions in any number of directions or gestures may be associated with specific requests as well as other activities, such as locate a user, share exercise data, share a music playlist, enable a dictation feature, open a specified app, share user vitals, play music, pause, fast forward, rewind, activate a digital assistant (e.g., Siri, Alexa, Google, Cortana, smart assistant, etc.), or so forth without limitation. The swiping motions and gestures may also be utilized to control actions and functionality of wireless devices, or other external devices (e.g., smart television, camera array, smart watch, etc.) through wireless signals sent by the transceiver 516. The user may also provide user input for authorizing an action or request by moving his head in a particular direction or motion or based on the user's position or location. For example, the user may utilize voice commands, head gestures, or touch commands to change the content displayed by a wireless device as received from the wireless earpieces 502. For example, a user may provide a verbal command to “provide walking directions to my location to Mike.” The speaker of the user interface 514 may then provide audible instructions and indicators which may include direction, heading, suggested speed, obstacles in the path, suggestions, or so forth. The user interface 514 may also provide a software interface including any number of icons, soft buttons, windows, links, graphical display elements, and so forth for receiving user input.

In one embodiment, the user interface 514 may periodically utilize one or more microphones and speakers of the wireless earpieces to authenticate the user. The microphone of the user interface 514 may measure various voice characteristics including amplitude, shimmer rates (i.e., changes in amplitude over time) frequency/pitch, jitter rates (i.e., changes in frequency data over time), accent, voice speed, inflection, and so forth. Specific words, phrases, or sounds may be associated with actions as stored in the memory 512 and detected by one or more microphones of the user interface 514. The microphones may include external microphones positioned on the outside surface(s) of the wireless earpieces 502 (e.g., air microphones) as well as internal microphones (e.g., bone, ear-bone microphones, etc.). The wireless earpieces 502 may also recognize a pre-defined vocabulary. For example, specific words may be required to authenticate different requests and action types. The wireless earpieces 502 may function separately to identify two different users.

The sensors 517 may include inertial sensors, pulse oximeters, accelerometers, gyroscopes, magnetometers, water, moisture, or humidity detectors, impact/force detectors, thermometers, photo detectors, miniature cameras, microphones, and other similar instruments for identifying the user and reading biometrics as well as location, utilization of the wireless earpieces 502, orientation, motion, and so forth. The sensors 517 may also be utilized to determine the biometric, activity, location, speed, and measurements of the user. In one embodiment, the sensors 517 may store data that may be shared with other components (e.g., logic engine 510 determining a location of the user from satellite signals/data), users, and devices.

The sensors 517 may include photodetectors, ultrasonic mapping devices, or radar that scan the ear of the user when positioned for utilization. The sensors 517 may generate a two or three dimensional scan or topography map of the user's ear and surrounding areas when the wireless earpieces 502 are properly positioned. The mapping may include the internal and/or external portions of the user's ear. The topographical image of the user's ear may be utilized as a stand-alone biometric identifier or may be utilized with other biometric identifiers to identify the user. The image may include the external auditory meatus, scapha, fossa triangularis, scaphoid fossa, helix, antihelix, antitragus, lobule, the tragus, and pinna as well as other internal or external portions of the ear and surrounding head structure.

Externally connected wireless devices may include components similar in structure and functionality to those shown for the wireless earpieces 502. For example, a wireless device may include any number of processors, batteries, memories, busses, motherboards, chips, transceivers, peripherals, sensors, displays, cards, ports, adapters, interconnects, sensors, and so forth. In one embodiment, the wireless device may include one or more processors and memories for storing instructions. The instructions may be executed as part of an operating system, application, browser, or so forth to implement the features herein described. For example, the user may set preferences for the wireless earpieces 502 to work individually or jointly to identify user biometrics for comparison against known values to verify the user is authorized to search for, locate, or track a tag. Likewise, the preferences may manage the actions taken by the wireless earpieces 502 in response to identifying specific users are utilizing the wireless earpieces 502. For example, a parent user may have full access to track any number of wireless earpieces, but a juvenile user may only have access to track the other wireless earpiece of a paired set. In one embodiment, the wireless earpieces 502 may be magnetically or physically coupled to the wireless device to be recharged or synchronized.

The wireless device may also execute an application with settings or conditions for updating, synchronizing, sharing, saving, processing requests and utilizing biometric information. For example, one of the sensors 517, antennas, or transceivers that may have failed may be ignored in response to improper or unreliable data being gathered. As a result, the user identification and communication processes for performing authorizations may be dynamically performed utilizing any combination of sensor measurements. For example, the number and position of the sensors 517 utilized to perform status determinations for the user may vary based on failures, inaccurate data, or other temporary or permanent issues with hardware and software of the wireless earpieces 502.

In one embodiment, at least one antenna or sensor may be configured to be in a line of sight of at least one GNSS satellite array and to detect and receive signals from one or more GNSS satellite arrays. As noted, the signals from the GNSS satellite array may be radio waves or any other type of electromagnetic signal in commercial use. As noted, the wireless earpieces may include air microphones and bone conductions microphones that may scan for sound, noises, or vibrations which may be used to help determine a user's location. In another example, an inertial sensor may also be used to correct or otherwise modify any calculations performed by the logic engine 510 in calculating a user's location. The transceiver 516, infrared sensors, or other radio sensors may detect any number of different signals to facilitate tracking and identifying the location of the user. The sensors 517 may also include a chemical sensor 44 may be used to provide a warning to the user if dangerous gases or liquids are detected. The chemical sensor may be configurable by a user to detect any type of chemical that may be deemed harmful to a user.

In one embodiment, the user interface 514 may include any number and type of speakers (e.g., treble, mid-range, bass, etc.) that may communicate audio and sound to the user including entertainment, biometric information, indicators, warnings, or so forth.

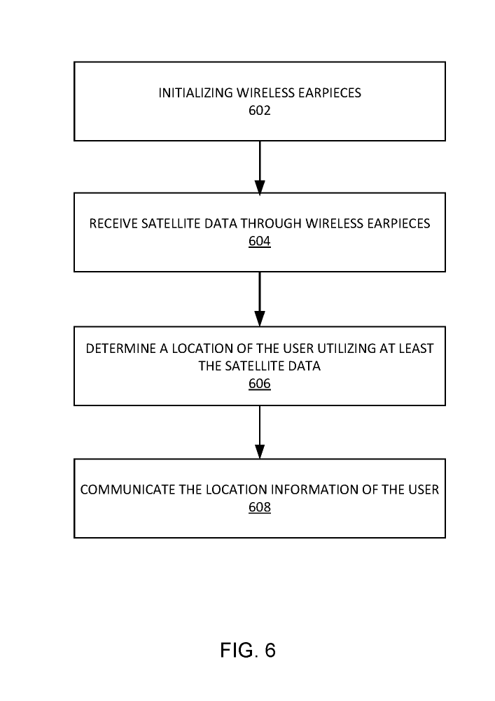

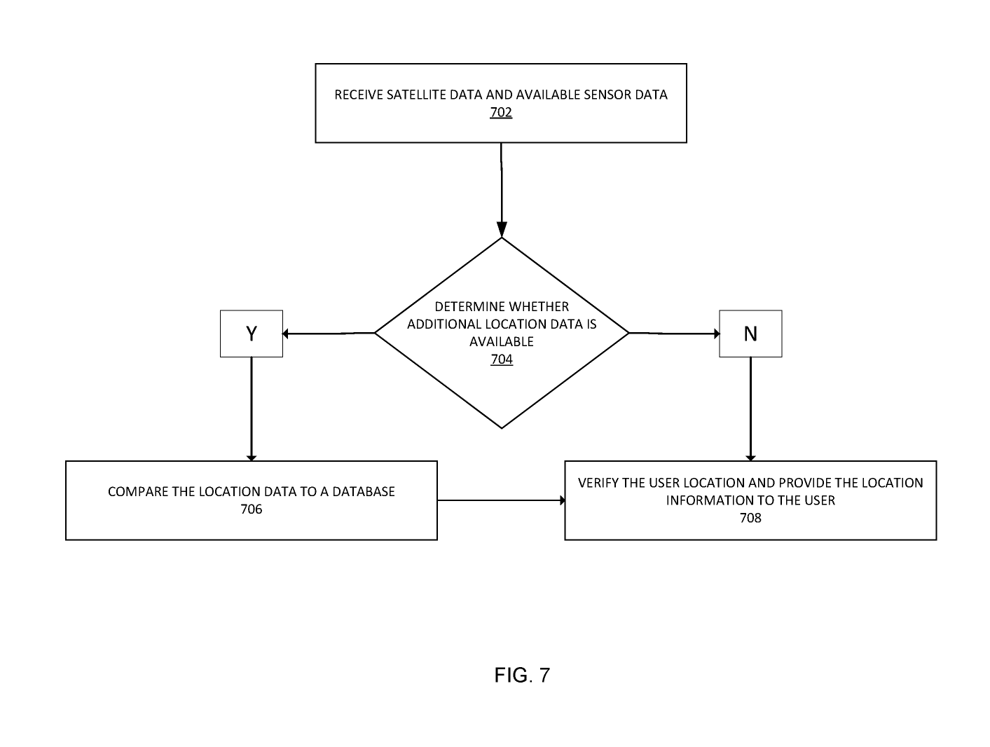

FIG. 6 illustrates a flowchart of a process for performing satellite communications in accordance with an illustrative embodiment. The process of FIGS. 6 and 7 may be performed by one or more wireless earpieces. In one embodiment, both wireless earpieces may determine the location, and orientation of a single user. In another embodiment, two different users may wear each of a pair of wireless earpieces including a first, left wireless earpiece and a second, right wireless earpiece. An individual wireless earpiece may also be utilized.

The process may begin by initializing wireless earpieces (step 502). The initialization of step 602 may include being powered on, activated, removed from a charging/storage case, or so forth. In one embodiment, the wireless earpieces may be initialized in response to being removed from a smart case. In another embodiment, the wireless earpieces may be initialized in response to the wireless earpieces being positioned in ears of the user. Placing the wireless earpieces within the earpiece as can be verified with contact sensors or receiving biometric data consistent with placement in the ears can be useful as it establishes a position of the earpiece, e.g. placed within the ear of the user. Thus, relative locations to other parts of the body of the user or other body worn devices on the user may be determined using appropriate offsets. In another embodiment, the wireless earpieces may be initialized in response to a power switch being activated. In another embodiment, the wireless earpieces may be initialized in response to a voice command, touch gesture, tactile input, or so forth. In another embodiment, an application or software module may be activated.

Next, the wireless earpieces receive satellite data through the wireless earpieces (step 604). The satellite data may be received from a GNSS array, individual satellites, or so forth. One or more different antennas and transceivers may be utilized to receiver the satellite signals. The body of the user may also be utilized as an antenna to better receive and send signals. Additional devices worn, carried, or in close proximity to the user may also be utilized to receive the satellite data. The satellite data may represent continuous or discrete data.

Next, the wireless earpieces determine a location of the user utilizing at least the satellite data (step 606). In one embodiment, the logic engine/processor may calculate the location of the user utilizing the data from multiple satellites in order to perform triangulation. The wireless earpieces may also utilized data from secondary sources, such as cellular networks, wireless local area networks, beacons, indicators, or so forth. Sensory data, such as images, audio, or so forth, may also be utilized to determine or verify the location of the wireless earpieces and associated user. In another embodiment, verification or authentication of the location may be performed as a separate step of the process of FIG. 6.

Next, the wireless earpieces communicate the location information of the user (step 608). The location information may specify the location, relative position, body position and orientation, coordinates, altitude, and so forth. The location information may be communicated to the user himself/herself or to any number of third parties. The communication of the information may be communicated audibly, visually, tactilely, or through a connected device. The location and orientation of the user may also be communicated directly or indirectly to any number of devices. For example, a satellite, cellular, Bluetooth, Wi-Fi, NFMI, or other connection, signal, or network may be utilized.

FIG. 7 is a flowchart of a process for verifying location information in accordance with an illustrative embodiment. The process of FIG. 7 may begin by receiving satellite data and available sensor data (step 702).

Next, the wireless earpieces determine location information associated with the user utilizing the satellite data (step 704). As previously noted, the satellite data may include GNSS, GPS, or other satellite data.

Next, the wireless earpieces determine whether additional location data is available (step 706). In one embodiment, the wireless earpieces may determine whether there is data available from microphones, cameras, gyroscopes, accelerometers, infrared sensors, or so forth.

If the wireless earpieces determine there is additional location data available from the sensors, other components, or external devices, the wireless earpieces compare the location data to a database (step 706). In one embodiment, the sensors include one or more imaging devices. A database of optical images are utilized to determine the location of the user. The database may be stored locally on the wireless earpieces, on a connected wireless device/app, or remotely in a cloud-based or web-based networking system. For example, rock formations may be utilized to identify that user's exact location in Moab Utah. In another embodiment, the sensors may include auditory data. Sounds and noises of the environment may be utilized to determine the user's exact or approximate location. For example, noises from a specific type of frogs indigenous only to Puerto Rico (e.g. coqui) may be utilized to narrow a user's location down to a beach in Humacao, Puerto Rico. Other databases and information may also be utilized to determine location.

The audio signals received by one or more microphones may originate from the user, a third party, a machine, an animal, the natural environment, or another electronic device, and may be instructional commands issued by the user or a third party or sound waves to be used in conjunction with geographic data to help ascertain a user's location. The external location data may be of any type helpful in ascertaining the user's location. The reception of the data may be in any order. One or more processors or logic engines may then calculate the user location from satellite data and the sensor data. The algorithms used to calculate the user data may be stored within a logic engine/processor itself, a data storage device located within the wireless earpiece, or an external device operatively connected to the processor. The processors need not consider all data that is received to determine the location information.

Next, the wireless earpieces verify the user location and provide the location information to the user (step 708). During step 708, the location information determined from the satellite is updated as necessary. In some embodiments, the location information is enhanced based on increased resolution. If the wireless earpieces determine there is not additional location data available, the wireless earpieces may provide the location information to the user (step 708).

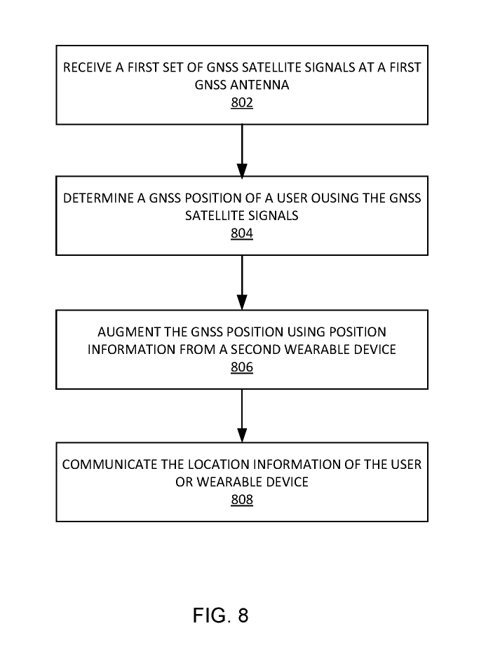

FIG. 8 illustrates another example of the method of location determination of a wireless earpiece and a user wearing the wireless earpiece. In step 802, a first set of global navigation satellite system (GNSS) satellite signals are received at a first GNSS antenna of a first wireless earpiece. In step 804 a determination of a GNSS position of the user of the wireless earpiece is made using the set of GNSS satellite signals. Thus, for example, a GNSS receiver may determine location from the GNSS satellite signals. In step 806 the GNSS position is augmenting using position information from a second wearable device of the user to provide a location determination more accurate than the GNSS position of the user determined using the GNSS satellite signals at the first GNSS antenna of the first wireless earpiece. This augmentation may take various forms. For example, the second wearable device may have a second GNSS antenna for receiving a second set of GNSS satellite signals. Thus, the first set of

GNSS satellite signals may be from a set of satellites different from the set of satellites for the second set of GNSS satellite signals. The second wearable device may be an earpiece. Where a left and a right earpiece are worn by a user, the earpieces will be on opposite sides of the body and thus may be in line-of-sight of different sets of GNSS satellites. Similarly, the wearable device may be placed at any number of different locations on the body that may result in receiving different sets of GNSS satellite signals. The location determined by the first wireless earpiece may be augmented in various ways. This may include modifying the location with the location determined by the second wearable device and accounting for offsets due to varying location on the body. This may include varying the location based on network data such as triangulated and signal strength information for cellular networks, Wi-Fi networks, Bluetooth networks, mesh networks or other available networks. This may include modifying location information based on beacon signals, comparison of audio signals or imagery or other optical signals to a database of known audio signals or known images. Such a database may be stored within the wireless earpiece or may be located at a remote location and accessed over a network.

The illustrative embodiments are not to be limited to the particular embodiments described herein. In particular, the illustrative embodiments contemplate numerous variations in the type of ways in which embodiments may be applied. The foregoing description has been presented for purposes of illustration and description. It is not intended to be an exhaustive list or limit any of the disclosure to the precise forms disclosed. It is contemplated that other alternatives or exemplary aspects are considered included in the disclosure. The description is merely examples of embodiments, processes or methods of the invention. It is understood that any other modifications, substitutions, and/or additions may be made, which are within the intended spirit and scope of the disclosure. For the foregoing, it can be seen that the disclosure accomplishes at least all of the intended objectives.

The previous detailed description is of a small number of embodiments for implementing the invention and is not intended to be limiting in scope. The following claims set forth a number of the embodiments of the invention disclosed with greater particularity.

What is claimed is:

1. A method of location determination using a first wireless earpiece, the method comprising steps of:
receiving a first set of global navigation satellite system (GNSS) satellite signals at a first GNSS antenna of the first wireless earpiece;
determining a GNSS position of a user of the first wireless earpiece from the first set of GNSS satellite signals; and
augmenting the GNSS position of the user of the first wireless earpiece using position information from a second wearable device of the user to provide a location determination more accurate than the GNSS position of the user determined using the GNSS satellite signals at the first GNSS antenna of the first wireless earpiece.

2. The method of claim 1 wherein the second wearable device of the user comprises a second GNSS antenna for receiving a second set of GNSS satellite signals, wherein the first set of GNSS satellite signals is from a set of satellites different from the second set of GNSS satellite signals.

3. The method of claim 2 wherein the second wearable device is a second wireless earpiece.

4. The method of claim 1 wherein the position information from the second wearable device is determined based on network data.

5. The method of claim 4 wherein the network data is cellular network data.

6. The method of claim 4 wherein the network data comprises mesh network data.

7. The method of claim 1 wherein the position information from the second wearable device is determined based on sensor data from at least one sensor of the second wearable device.

8. The method of claim 7 wherein the sensor data comprises at least one audio signal and wherein the at least one sensor comprises at least one microphone.

9. The method of claim 7 wherein the sensor data comprises imagery and wherein the at least one sensor comprises at least one camera.

10. The method of claim 9 wherein the position information from the second wearable device is obtained by comparing the imagery to a database of images and image locations.

11. The method of claim 1 further comprising communicating the location determination to the user.

12. The method of claim 1 further comprising communicating the location determination to a wearable device worn by the user.

13. The method of claim 1 further comprising initializing the first wireless earpiece.

14. The method of claim 13 wherein the initializing comprises confirming the first wireless earpiece is worn by the user.

15. The method of claim 14 wherein the confirming the first wireless earpiece is worn by the user comprises detecting a biometric parameter at the earpiece.

16. The method of claim 15 further comprising determining a position of a point on a body of the user based on the location determination and an offset.
